(19) United States
(12) Patent Application Publication
(10) Pub. No.: US 2009/0037483 A1
(43) Pub. Date: Feb. 5, 2009

(54) System, Method and Apparatus for Dynamically Expanding the Functionality of Legacy Systems

(76) Inventor: Steven J. Christensen, Cedarburg, WI (US)

Correspondence Address: Steven Christensen, 1765 Creek Ridge Court, Cedarburg, WI, 53012, US

(21) Appl. No.: 11/877,565

(22) Filed: Oct. 23, 2007

Related U.S. Application Data
(60) Provisional application No. 60/854,429, filed on Oct. 26, 2006.

(51) Int. Cl. G06F 17/30

(52) U.S. Cl. 707/200; 707/E17.009

(57) ABSTRACT

A system, method and apparatus for expanding the functionality of a Legacy System which receives a Structured Data File from a Legacy System User Interface, performs a Thumb Print Configuration Process, creates a Thumb Print Data File that is further processed by a Recognition Software Component and Novel Attribute Assignment Software Component to add Novel Data Elements, and which creates an Updated Data File which expands the functionality of a Legacy System and creates an creates an Updated User Interface.

### CROSS REFERENCE TO RELATED APPLICATIONS

This application claims priority to U.S. Provisional Patent Application N. 60/854,429 filed on Oct. 26, 2006, and incorporated herein in its entirety.

### FIELD OF INVENTION

This invention relates generally to the field of interactive software applications, and more specifically to a system, method and process for expanding the functionality of existing Legacy Systems while minimizing or eliminating the need to replace or integrate them with new software.

### BRIEF DESCRIPTION OF THE DRAWINGS

FIG. 1 is a diagram of a system for processing a transaction in a manner that reflects a change in a business process without the need to update a Legacy System.

FIG. 2 is an exemplary embodiment of a “Thumbprint” Data File created by the system described herein to assign Attributes to Data Elements present in a transaction created by a Legacy System.

FIG. 3 is an exemplary embodiment of a Data Attribute File to which Processing Attributes have been assigned to update and expand the functionality of a Legacy System.

FIG. 4 is a flowchart of a method for processing a Transaction in a manner that reflects a change in a business process without the need to update a Legacy System.

### BACKGROUND

Terminology

The following is an alphabetical list of some of the terms used in connection with the system, method and apparatus for expanding the functionality of a Legacy System:

As used herein, the term “attribute” generally refers to definitions assigned to Data Elements. These definitions control the processing of the associated Data Element and are assigned by Software Components that compile Software Objects.

As used herein, the term “attribute database” generally refers to a database created by an Object.

As used herein, the term “characteristic value” generally refers to an Attribute assigned to Data Elements that describe Transaction characteristics. Characteristic values include but are not limited to “screen identifiers,” “field names,” data and “local stored.”

As used herein, the terms “component” and “software component” generally refer to any software system element offering predefined services and operations and able to communicate with other Components.

As used herein, the term “data” generally refers to any information capable of being processed or stored by a software system, including isolated datum.

As used herein, the term “data element” generally refers to data stored or created in a software system. Data elements may be represented as fields in a table.

As used herein, the term “data attributes configuration process” generally refers to the process of assigning one or more Data Elements as Novel Data to the Thumbprint Data File to create the Novel Data Attributes of a Transaction.

As used herein, the term “defined value” generally refers to an Attribute assigned to Data Elements that impacts how the system, method and apparatus herein will process and store Data and information related to Transactions.

As used herein the term “element data” generally refers to an Attribute assigned to Data Elements which are used to create a recognized Thumbprint and/or Thumbprint Data File during the process of Thumbprint Configuration. Examples of Element Data types include but are not limited to operational, presentational and transactional.

As used herein, the term “element name” generally refers to an Attribute assigned to Data Elements for use in the method and system described herein. An Element Name may or may not be used or recognized by a Legacy System.

As used herein, the terms “integration” and “integrating” generally refer to the process of adding new capabilities or functionality to an existing system by creating new software to perform additional functions, or to render the existing software compatible with other software applications.

As used herein, the term “interface value” generally refers to an Attribute which controls communication with the Legacy System. For example, in the case of a Legacy System that utilizes a telnet file/session as a User Interface, the value may be set to “real time” if the Legacy System is dependent upon information conveyed by the method and system herein to maintain their process control of Transactions. In another example, the Interface Value may be set to Local as the data management of this field may be an additive process to the Legacy System requirements for which Data is stored locally on the system described herein.

As used herein, the term “invoking” generally refers to an established communication method between two Objects. One Object may invoke the other by recognizing the required next step in a multi-object process requires a particular Object to take the Data and conclude the Transaction.

As used herein, the term “Legacy System” generally refers to one or more existing systems deployed in one or more organizations, which may include any existing interactive business system, production, or operational system. Examples of Legacy Systems include but are not limited to centralized ERP systems (SAP, Oracle, etc.), custom application development and other Best of Breed systems (Warehouse Management, Intransit Visibility, RFID, Manufacturing, etc.), or any other “shop floor,” warehouse, inventory, delivery, field service, field sales, intransit visibility, customer tracking system, order tracking system, file tracking system or any combination or variation thereof.

As used herein, the term “legacy system user interface” generally refers to an interface defined by the Legacy System and can include generated reports/transactions printed on paper or generated reports/transactions displayed on a computer screen.

As used herein, the terms “manual processing” and “manual transaction” generally refer to a Transaction which is at least partially accomplished using Data transmitted or stored on paper rather than electronically.

As used herein, the terms “mobile computing device” and “mobile computing” generally refer to a device which is used remotely or in transit to transmit data, including but not limited to devices which use satellites, radio systems and lasers. Mobile Computing Devices may be connected to a networked application server using an Ethernet connection, wireless local area network connection, 802.1X wireless connections, wireless wide area network connection, Bluetooth, Zigby or WiFi wireless.

As defined herein the term “mobile user” generally refers to any worker/employee of the aforementioned manufacturer, wholesaler, retailer or local and federal government; further defined as employees who need to access Data but are not often at a stationary point currently served by a wired network solution only served by printer and personal or networked computers.

used herein, the term “mobilizing” generally refers to the process of updating or tracking Transactions in real time using Mobile Computing Devices that previously were performed as a Manual Process. An example of Mobilizing a Transaction is taking a paper based transaction and displaying it on a Mobile Computing Device.

As used herein, the term “novel data attributes” or “novel data” generally refers to any data or information potentially related to any Transaction not currently tracked or processed by a Legacy System, and which would require modifications to an existing Legacy System or interactive inventory application to track and process. Novel Data Attributes may include any modifications to processing of Recognized Data as well as new Data Elements not currently tracked by the Legacy System.

As used herein, the terms “object” and “software object” generally refer to any software which is dynamically created by a Software Component. An Object has similar characteristics as a Software Component, but is used in the execution of a Transaction.

As used herein, the terms “operational parameters” and “operational data” generally refer to an Attribute assigned to Data Elements found in a Structured Data File which defines the attributes of Data which may be accepted as input by a Legacy System. Examples of Operational Parameters include but are not limited to alphanumeric and alpha only data characteristics or scannable and keyboard as acceptable methods of input.

As used herein, the terms “presentation data” of and “presentational” generally refer to an Attribute assigned to Data Elements found in a Structured Data File which determines the appearance of a user interface. Examples of Presentation Data include but are not limited to control characters recognized by other devices through established character sets.

As used herein, the term “processing attribute” generally refers to any Data or combination of data which impacts how a Transaction is processed. Examples of Processing Attributes include, but are not limited to an Interface Value, a Tracking Data, a Table Value, Attribute Data, an Element Name, a Characteristic Value, a Defined Value, a Validation Methods Value, a Sequencing Value or any combination thereof.

As used herein, the term “recognized data” generally refers to any data which a Legacy System is capable of recognizing and processing.

As used herein, the term “recognition object” generally refers to an Object configured to recognize data from a Transaction initiated by a Legacy System or user of a Legacy System, or an instance or occurrence of such a Transaction. A Recognition Object also may maintain the communication with the Legacy System according to the processing requirements of that system and returns the Recognized Data in the sequence and manner consistent with the design of the Legacy System.

As used herein, the term “sequencing value” generally refers to an Attribute assigned to Data Elements which controls the sequence and order in which Data appears on a user interface.

As used herein, the term “server” generally refers to an application or device that performs services. A server may accept connections in order to service requests by sending back responses, and may be distributed over one or more computing devices on a wired or wireless network, including but not limited to a Mobile Computing Device or computer.

As used herein, the term “structured data file” generally refers to one or more particular file formats used to encode information for storage in a computer file. Contents of a Structured Data File may include data type, size, naming conventions, and organization of data. Exemplary types of Structured Data Files include but are not limited to printer control files, text files, terminal emulation/telnet, markup languages, word processing documents, desk top publishing documents, spreadsheets, portable document formats, comma separated values, and web services and other type of such structured files for use in presenting or storing data.

As used herein, the term “system administrator” generally refers to a person or automated process that assists in maintaining a software system, including any embodiment of system, method and apparatus described herein.

As used herein the term “table value” generally refers to an Attribute assigned to Data Elements which may be stored in a table.

As used herein, the term “thumbprint configuration” generally refers to the process of assigning one or more Attributes to the Data Elements of a Structured Data File.

As used herein, the terms “thumbprint” and “thumbprint data file” generally refer to one or more recognizable patterns of a Structured Data File to which transactional, operational, and presentational attributes have been recognized and/or assigned by a System Administrator, to identify a unique transaction.

As used herein, the term “thumb printing software component” generally refers to software which performs the Thumb Print Configuration.

As used herein, the term “tracking data” generally refers to an Attribute assigned to Data Elements to determine whether or not data is maintained locally by the system, method and apparatus described herein.

As used herein, the terms “transaction” and “business transaction” generally refer to an economic or non-economic event that occurs in a business or other entity and that is recorded and/or tracked. A Transaction may include but is not limited to events which occur in manufacturing, wholesaling and retail, governmental, medical, academic, archival and other contexts, or in any entity which is a combination of or analogous to the foregoing.

As used herein, the term “transaction data” generally refers to an Attribute assigned to Data Elements found in a Structured Data File to identify substantive information relevant to a Transaction.

As used herein, the term “updated user interface” generally refers to a new user interface defined by the system, method and apparatus described herein that may or may not have any resemblance to the Legacy System User Interface, examples of which include generated reports/transactions printed on paper or generated reports/transactions displayed on a computer screen.

As used herein, the term “updated data file” generally refers to any data file that has been modified to add functionality to a Legacy System. The contents of an updated data file include Data Elements and may include one or more Attributes.

As used herein, the term “user interface” generally refers to the part of the design of a computer, device, output or program that accepts commands from and returns information to the user. A User Interface may include, but is not limited to, printed, paper, computer generated or other visual or audio components capable of prompting and/or receiving manual (such as writing) or electronic (such as bar code scanning, imaging, RFID, speech recognition) input.

As used herein, the term “validation methods value” generally refers to an Attribute assigned to Data Elements which controls whether a device or peripheral may be used or recognized by the system, method and apparatus described herein, and whether or not data is to be stored locally for processing or stored in a manner to permit the data to be retrieved. A Validation Methods Value may include but is not limited to speech recognition data capture, bar code scanning, bar code imaging, imaging, labeling, RFID, tracking temperature and cold chain compliance data.

Context of Technology

Interactive software systems are used by manufacturers, wholesalers, retailers and government entities to record transactions and events, track their inventory, update order status and execute their Transactions. Once designed and implemented, these applications require substantial investment to update or replace. They are often referred to in the industry as “Legacy Systems.” In the rapidly evolving information technology industry, a Legacy System may be “old” as soon as it is implemented, because business processes for which they record Transactions need to be or have already been modified. Legacy Systems may eventually be upgraded to reflect changes in business processes, replaced or archived.

It is costly to modify or replace a Legacy System when a business needs to track and process data or store information due to a change in a business process-that the Legacy System was not originally designed or configured to track.

Businesses are often faced with two equally risky propositions: replacing or integrating. Replacing proven, existing Legacy Systems with new interactive software applications introduces risk, requires the loss of previous investment in the system, and diminishes productivity while the new system is implemented. Integrating also results in substantial costs, including software design, software development, installation support, training, testing and change management. Integration costs are a primary reason why project decisions are delayed and/or abandoned in a business environment. The risk/reward analysis often reveals that the cost of software integration is too high, and is further exacerbated by a risk of inefficiency from system “bugs” resulting from integration.

Integrating generally does not result in long term savings over replacement. Integration creates unique risks to the organization, requires retention and supervision of highly specialized consultants and employees, and impedes the ability to upgrade to new versions of the Legacy System. Integration often requires that the companies continuously “re-integrate” their systems after modifications are made to the Legacy System.

Since business processes, legal and regulatory environments, technological advance, industry and consumer preferences are in a constant state of change, it is necessary for businesses to continuously be able to track new and existing data types using more productive processes and advanced data capture technologies. Data types and data collection methods must reflect changes in business processes that were not contemplated when Legacy Systems were first implemented. For example, many processes which are tracked manually on paper or using printers can or should now be updated so they can be tracked in real time using Mobile Computing Devices (hereinafter referred to as “Mobilizing”). Other business processes need to change to track new types of data that were not contemplated when a Legacy System was initially implemented are referred to herein Novel Data. For example the ability to begin tracking pallet, case and item level RFID tags may be beyond the scope of a Legacy System, as designed and updated. And yet other business processes need to be updated to reflect new data capture technology that may be beyond the scope of a Legacy System as designed and updated.

For the foregoing reasons, it is desirable to have an economical system for mobilizing manual transactions, changing how transactions are processed, including the streamlining of existing transaction processing, introducing new data capture technologies, and processing Novel Data Attributes, which does not require replacement or integration of Legacy Systems.

### DETAILED DESCRIPTION OF THE DRAWINGS

For the purpose of promoting an understanding of the present invention, reference will be made to multiple embodiments of a system, method and apparatus for expanding the functionality of a Legacy System. It is to be understood, however, that the present invention may be embodied in various forms. For example, elements and components of a system may be presented in varying manners, or steps of a method may be performed in a different order, and such representations are to be considered purely exemplary and representational of the elements or components that comprise the entire system, and not definitive of the order in which such components or elements perform a designated function.

Acts and symbolically represented operations or instructions may, but are not required to, include the manipulation of electrical or biological signals by a CPU. Therefore, specific details and representations disclosed herein are not to be interpreted as limiting, but rather as a basis for the claims and as a representative basis for teaching one skilled in the art to employ the present invention. One of ordinary skill in the art will readily appreciate that modifications do not depart from the spirit and scope of the present invention, some of which are mentioned in the following description.

With particular reference to the figures, the reader should also know that like numerals in different figures may refer to the same elements of the embodiments. Moreover, it should be noted that each embodiment of the invention is not depicted by the figures.

Data may be maintained on a computer readable medium including magnetic disks, optical disks, organic memory, and any other volatile (e.g., Random Access Memory (“RAM”)) or non-volatile (e.g., Read-Only Memory (“ROM”)) mass storage system readable by a CPU. The computer readable medium includes cooperating or interconnected computer readable media, which exist exclusively on the processing system, or must be distributed among multiple interconnected processing systems that may be local or remote to the processing system or may be maintained by an outside entity or source.

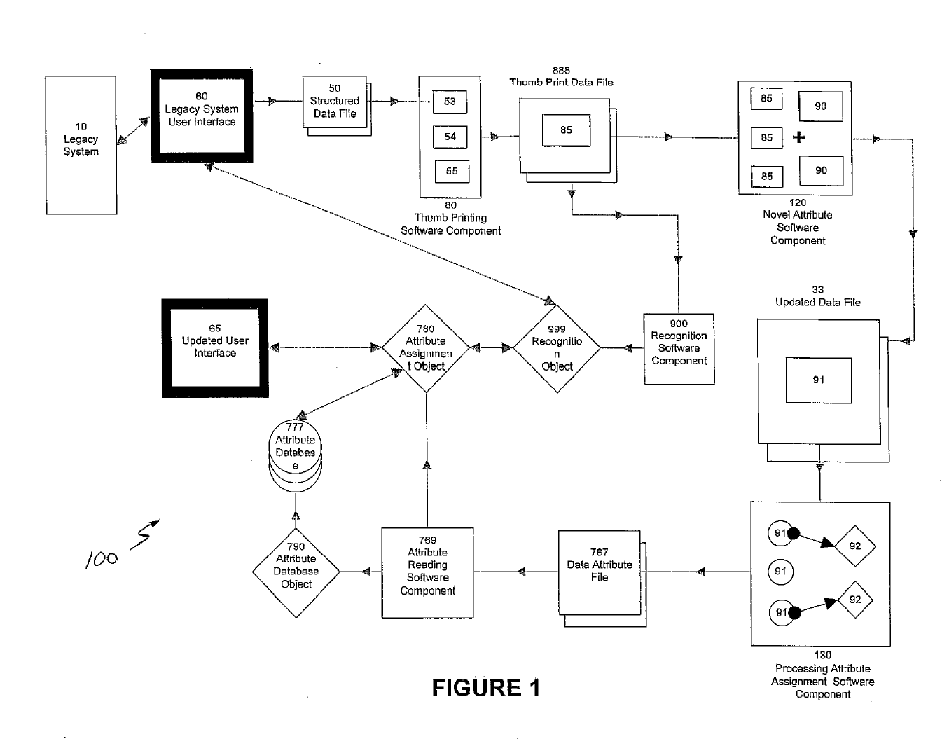

FIG. 1 shows an exemplary embodiment of Data Tracking System 100 for expanding the functionality of an existing Legacy System, by enabling Legacy System 10 to Mobilize transactions, change how Transactions are processed, and processing by Novel Data Attributes in conjunction with existing Legacy System User Interface 60.

In the embodiment shown, Structured Data File 50 is created by Legacy System 10. Structured Data File 50 includes Data that controls the appearance and processing of Legacy System User Interface 60 and define the types of data accepted as input by Legacy System 10. In an exemplary embodiment, Structured Data File 50 may include data to determine the appearance of fields for customer name, address, phone number, quantity and shipping on Legacy System User Interface 60, as well as other fields relevant to a Transaction.

Also shown in FIG. 1 is Thumb Printing Software Component 80, which performs the process of Thumb Print Configuration that enables a System Administrator to view the specific Data Elements in Structured Data File 50, obtained from Legacy System 10. Once the Data Elements are readable, the System Administrator has the capability to categorize, identify and assign Attributes to the Data Elements to signify the presence of specific Operational Data 53 Presentation Data 54 and Transactional Data 55 or other Data Elements referred to herein to as Recognized Data 85 as obtained from Structured Data File 50. This process of viewing and categorizing data by assigning Attributes by Thumb Printing Software Component 80 is called Thumb Print Configuration and creates Thumbprint Data File 888. Thumbprint Data File 888 functions, in part, as an inventory of the transactional, presentational and operational Data Elements or other such identifiable Data Elements contained in Structured Data File 50.

Also shown in FIG. 1 is Recognition Software Component 900. The function of Recognition Software Component 900 is to create Recognition Object 999 by utilizing Thumbprint Data File 888. In the embodiment shown, Recognition Object 999 resides on a server on a mobile computing device, but can reside on any wired or wireless networked computer or any combination thereof. Recognition Object 999 maintains communication with Legacy System 1 0 by utilizing Legacy System User Interface 60 and waits for a transaction to be initiated either by a user of Legacy System 10 accessing it through Updated User Interface 65, by Legacy System 10 itself, or Attribute Assignment Object 780 (discussed infra). The function of Recognition Object 999 is to recognize Legacy System User Interface 60, which Legacy System 10 uses to process the related Transaction and to invoke Attribute Assignment Object 780. Recognition Object 999 passes Recognized Data 85, contained in Legacy System User Interface 60, to Attribute Assignment Object 780. Recognition Object 999 is able to receive and interpret Legacy System User Interface 60 and communicate with Legacy System 10 a result of the Thumb Print Configuration Process discussed supra. Recognition Object 999 also receives Recognized Data 85 back from Attribute Assignment Object 780 once the user performs a Transaction utilizing Updated User Interface 65. Recognition Object 999 provides the updated Data Elements in the sequence and manner required by Legacy System 10 to maintain Recognized Data 85 in the sequence and manner consistent with the design of Legacy System 10.

Also shown in FIG. 1 is Novel Attribute Software Component 120. The function of Novel Attribute Software Component 120 is to: (1) receive Thumbprint Data File 888, which contains Recognized Data 85 that has been configured by a System Administrator, and (2) to create Updated Data File 33, which may include Novel Data 90 added by a System Administrator to Recognized Data 85, collectively referred to herein as Novel Data Attributes 91. Novel Data 90 may be added to Thumbprint Data File 888 in any number or combination to create Updated Data File 33 containing Novel Data Attributes 91. The addition of Novel Data 90 enables Data Elements to be added to the Transaction without modifying Legacy System 10 or requiring software to be integrated or substantially integrated with Legacy System 10 to include such Data Elements. In an exemplary embodiment, a System Administrator may add Novel Data 90 to begin the generation, tracking and retention of RFID information not currently tracked by Legacy System 10.

Also shown in FIG. 1 is Processing Attribute Assignment Software Component 130 which receives Updated Data File 33. The function of Processing Attribute Assignment Software Component 130 is to enable a System Administrator to assign one or more Processing Attributes 92 to each Novel Data Attributes 91 contained within Updated Data File 33. Processing Attributes 92 control how Novel Data Attributes 91 are to be stored, processed, displayed, validated, sequenced, and interfaced in the Transaction now required by the operation. This capability of assigning Processing Attributes 92 to Updated Data File 33 creates Data Attribute File 767. Data Attribute File 767 functions, in part, as a definition of the new Transaction required by the operation but not supported by Legacy System 10. In an exemplary embodiment, a System Administrator may assign Processing Attributes 92 to Updated Data File 33 to allow a change in the Transaction to process speech recognition data capture, although Legacy System 10 has not been updated, and therefore has no process to accommodate that technology. Other embodiments may add various capabilities and functionality to Legacy System 10, including but not limited to bar code scanning, bar code imaging, imaging, labeling, RFID, tracking product information, capturing additional inventory data, capturing regulatory data, capturing or generating customer compliance data, tracking temperature and cold chain compliance data, aging data, quality control data, customer service data, commission and fee data, and maintenance and repair data or other such expansions to the functionality.

Data Attribute File 767 is read by Attribute Reading Software Component 769, which in turn creates Attribute Assignment Object 780. Attribute Assignment Object 780 controls how Novel Data Attributes 91 are stored, processed, displayed, validated, sequenced, and interfaced. Attribute Assignment Object 780 may determine the appearance of Updated User Interface 65. In the embodiment shown, Updated User Interface 65 replaces Legacy System User Interface 60 as the User Interface of the Transaction.

Attribute Reading Software Component 769 further creates Attribute Database Object 790, which controls the creation of related Attribute Database 777 and establishes the databases, tables and field structures for the updated business processes as defined by Data Attribute File 767. These databases, tables and field structures are populated when Attribute Assignment Object 780 is invoked and receives input through Updated User Interface 65.

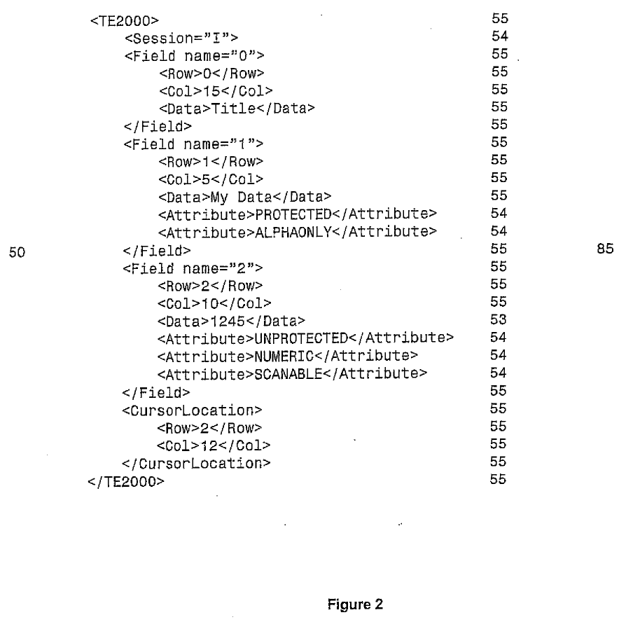

FIG. 2 is an exemplary embodiment of Thumbprint Data File 888 generated by Thumb Printing Software Component 80 which contains content of Structured Data File 50 Data Elements received from Legacy System 10 and the Attributes of Operational Data 53, Presentation Data 54, and/or Transactional Data 55 or other Recognized Data Elements 85, which have been assigned by a System Administrator using Thumb Printing Software Component 80. In the exemplary embodiment show, Structured Data File 50 is created by the commercially available Intermec Technologies Incorporated TE 2000™ software, but different commercial software products and vendor solutions may be used in other embodiments.

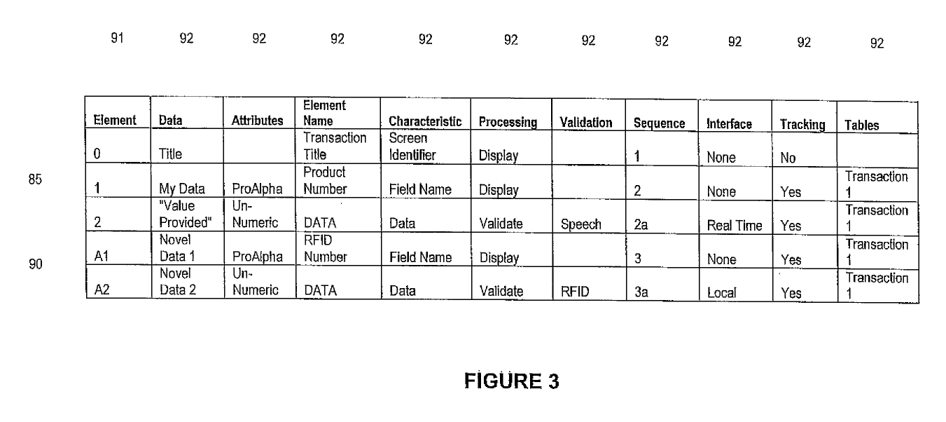

FIG. 3 is an exemplary embodiment of a table used to assign Processing Attributes 92 to each Novel Data Attributes 91 generated by Novel Attribute Software Component 120. Novel Data Attributes 91 includes both Recognized Data 85 and Novel Data 90. FIG. 3 shows exemplary Processing Attributes 92 for Novel Data Attributes 91.

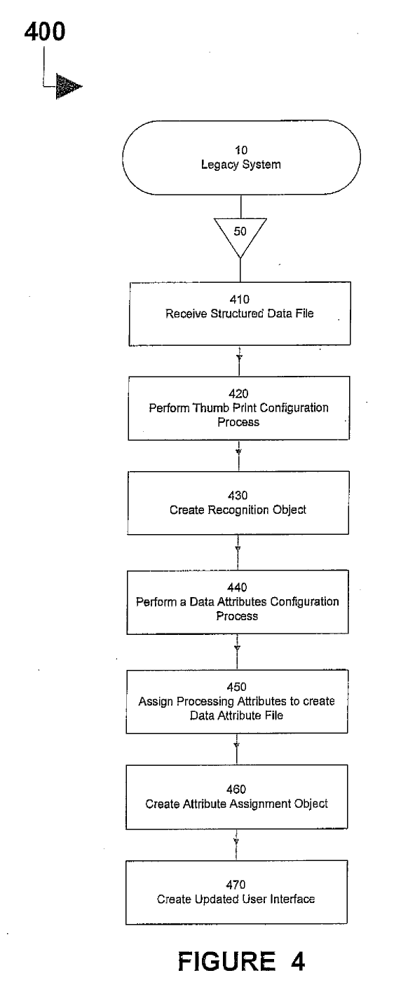

FIG. 4 is a flowchart of method 400 for processing a transaction in a manner that reflects a change in business processes without the need to update the Legacy System. In the embodiment shown, method 400 includes step 410 of receiving Structured Data File 50 from Legacy System 10. Other embodiments may omit this step or may receive multiple Structured Data Files from more than one Legacy System 10.

In the embodiment show, method 400 further includes step 420 of performing a Thumbprint Configuration Process and creating a Thumb Print Data File using configuration input from a System Administrator. The Thumb Print Configuration Process enables a System Administrator to view the specific Data Elements in a Structured Data File and to identify and assign Attributes to the Data Elements within the Structured Date File to signify the presence of specific Operational Data, Presentation Data, Transactional Data or other Data Elements (referred to herein as Recognized Data.)

FIG. 4 further shows step 430 of creating Recognition Object to receive a Structured Data File from the Legacy System User Interface. In the embodiment shown, the Recognition Object maintains communication with Legacy System 10 by utilizing the Legacy System User Interface and waits for a transaction to be initiated either by a user of Legacy System 10 accessing it through Updated User Interface, by the Legacy System itself, or Attribute Assignment Object (discussed infra). The function of Recognition Object is to recognize the Legacy System User Interface which Legacy System 10 uses to process the related Transaction and to invoke Attribute Assignment Object. In the embodiment shown, the Recognition Object passes Recognized Data contained in Legacy System User Interface to Attribute Assignment Object. As also in the embodiment shown, Recognition Object is configured to receive and interpret a Legacy System User Interface and communicate with Legacy System 10 as a result of the Thumb Print Configuration Process discussed supra. Also in the embodiment shown, the Recognition Object is configured to receive Recognized Data back from Attribute Assignment Object once the user performs a Transaction utilizing an Updated User Interface. In the embodiment shown, Recognition Object provides the updated Data Elements in the sequence and manner required by a Legacy System to maintain the Recognized Data in the sequence and manner consistent with the design of the Legacy System. In other embodiments, the Recognition Object may perform fewer or additional functions, or may perform substantively equivalent functions in the same or a different order.

Method 400 further includes Step 440 of performing a Data Attributes Configuration Process and creating an Updated Data File which may include Novel Data added by a System Administrator to Recognized Data, collectively referred to herein as Novel Data Attributes. Novel Data may be added to Thumbprint Data File in any number or combination to create Updated Data File containing Novel Data Attributes. The addition of Novel Data enables Data Elements to be added to the Transaction without modifying Legacy System or requiring software to be integrated or substantially integrated with Legacy System to include such Data Elements. In an exemplary embodiment, a System Administrator may add Novel Data to begin the generation, tracking and retention of RFID information not currently tracked by the Legacy System.

FIG. 4 further shows Step 450 of creating a Data Attribute File by assigning Processing Attributes to the Updated Data file to determine how Novel Data Attributes are processed.

FIG. 4 further shows Step 460, which creates a Attribute Assignment Object configured to receive data from a Recognition Object and assigns processing attributes which determines how a Transaction to be initiated either by a user of Legacy System 10 accessing it through Updated User Interface, by the Legacy System itself, or Attribute Assignment Object is processed.

Finally, FIG. 4 shows Step 470, of creating an Updated User Interface using the Data and applications of the Attribute Assignment Object.

What is claimed is:

1. A system for expanding the functionality of a Legacy System comprising:
at least one Thumb Printing Software Component capable of receiving at least one Structured Data File from at least one Legacy System User Interface and capable of performing a Thumb Print Configuration Process to create at least one Thumb Print Data File;
at least one Recognition Software Component capable of receiving said at least one Thumbprint Data File and capable of creating at least one Recognition Object, said at least one Recognition Object being capable of receiving said at least one Legacy System User Interface from said at least one Legacy System and invoking at least one Attribute Assignment Object;
at least one Novel Attribute Software Component capable of being configured by a System Administrator to receive said at least one Thumbprint Data File and to modify said at least one Thumbprint Data File to create at least one Updated Data File,
at least one Processing Attribute Assignment Software Component capable of receiving said at least one Updated Data File and which may be configured by said System Administrator to assign Processing Attribute to at least one Novel Data Attributes and create at least one Data Attribute File; and
at least one Attribute Reading Software Component capable of receiving said at least one Data Attribute File and which creates at least one Attribute Assignment Object and at least one Attribute Database Object, said Attribute Assignment Object capable of responding to said at least one Recognition Object and further capable of processing said at least one Novel Data Attribute and creating at least one Updated User Interface, and said Attribute Database Object capable of creating at least one database, one table and one field.

2. The system of claim 1 wherein said at least one Thumb Printing Software Component is configured to enable said System Administrator to assign at least one Attribute selected from a group consisting of transactional, operational and presentational parameters.

3. The system of claim 1 wherein said at least one Thumb Print Data File includes at least one Data Attribute assigned by said Thumb Printing Software Component selected from a group consisting of transactional, operational and presentational data.

4. The system of claim 1 wherein said at least one Updated Data File includes at least one data type selected from a group consisting of said at least one Recognized Data and said at least one Novel Data.

5. The system of claim 1 wherein said at least one Novel Attribute Software Component is configured to allow a System Administrator to add data elements from a group consisting of Novel Data and Recognized Data to said at least one Updated Data File.

6. The system of claim 5 wherein said at least one Novel Attribute Software Component is configured to allow a System Administrator to add Novel Data to said at least one Thumb Print Data File to create said at least one Updated Data File which tracks at least one additional Data Element than currently is recognized by said at least one Legacy System.

7. The system of claim 6 wherein said Novel Attribute Software Component is configured to allow a System Administrator to add Novel Data which adds at least one function to said at least one Legacy System selected from a group consisting of speech recognition data capture, bar code scanning, bar code imaging, imaging, labeling, RFID, tracking product information, capturing additional inventory data, capturing regulatory data, capturing or generating customer compliance data, tracking temperature and cold chain compliance data, aging data, quality control data, customer service data, commission and fee data, and maintenance and repair data or other such expansions to the functionality or any combination or derivative thereof.

8. The system of claim 1 wherein said at least one Attribute Assignment Object controls an action performed upon data selected from a group consisting of data storage, data processing, data transmission, data display, data validation, data sequencing and data interfacing.

9. The system of claim 1 wherein said at least one Attribute Assignment Object creates said at least one Updated User Interface.

10. The system of claim 1 wherein said Updated User Interface is displayed on a hardware selected from a group consisting of a display on a mobile computing device display, a computer monitor, computer client, Thin Client, a web based interface, paper or audio rendition, an audible display or a graphical display or any combination or derivative thereof.

11. The system of claim 1 wherein said Recognition Software Component resides on server selected from a group consisting of a mobile computing device, a computer or a network of computers or any combination or derivative thereof.

12. A method for expanding the functionality of a Legacy System comprising the steps of:
receiving at least one Structured Data File created by at least one Legacy System;
performing a Thumbprint Configuration Process creating at least one Thumb Print Data file using configuration input from a System Administrator;
creating at least one Recognition Object configured to recognize a data from said at least one Legacy System, receive data from at least one Attribute Assignment Object and pass said data to said at least one Legacy System User Interface;
performing a Data Attributes Configuration Process which creates at least one Updated Data File by adding Novel Data to said at least one Thumb Print Data File;
assigning Processing Attributes to create at least one Updated Data File to create at least one Data Attribute File;
creating at least one Attribute Assignment Object configured to receive Recognized Data from and send Recognized Data to said at least one Recognition Object; and
creating at least one Updated User Interface.

13. The method of claim 12 wherein said Thumb Print Configuration Process further includes the steps of configuring at least one Structured Data File to make data elements contained within said Structured Data File visible to a System Administrator and receiving configuration input from a System Administrator.

14. The method of claim 12 wherein said at least one Attribute Assignment Object is created by an Attribute Reading Software Component.

15. The method of claim 12 wherein said Data Attributes Configuration Process includes using a Novel Attributes Software Component configured to receive said at least one Thumb Print Data File and using said at least one Novel Attributes Software Component to add Novel Data to create said Updated Data File.

16. The method of claim 12 in which said Recognition Object is configured to receives said data from said at least one Legacy System User Interface, to pass said Recognized Data to said Legacy System User Interface, receive said Recognized Data from said at least one Attribute Assignment Object, and pass said Recognized Data returned from said Attribute Assignment Object to said Legacy System User Interface to create said Updated User Interface.

17. The method of claim 12 which further includes the Step of using at least one Attribute Reading Software Component to create said at least one Attribute Assignment Object and at least one Attribute Database Object which creates at least one Attribute Database.

18. The method of claim 12 which further includes the Step of populating an Attribute Database using said at least one Attribute Assignment Object.

19. The method of claim 12 which further includes the Step of displaying said Updated User Interface on a Mobile Computing Device.

20. An apparatus to expand the functionality of a Legacy System comprising:
at least one server configured to communicate with at least one Legacy System;
said at least one server further configured to receive a Structured Data File from said at least one Legacy System User Interface;
said at least one server further configured to perform a Thumb Print Configuration Process;
said at least one server further configured to process Recognized Data using a Recognition Software Component;
said at least one server further configured to add Novel Data using a Novel Attribute Software Component;
said at least one server further configured to assign Processing Attributes using at least one Processing Attribute Assignment Software Component; and
said at least one server further configured to create an Updated User Interface.
